(19) United States
(12) Patent Application Publication
(10) Pub. No.: US 2026/0038125 A1
(43) Pub. Date: Feb. 5, 2026

(54) RIDGE EXTRACTION FOR VECTOR GRAPHICS SYNTHESIS

(71) Applicant: Adobe Inc., San Jose, CA (US)

(72) Inventors: Tarun Beri, Noida (IN); Avinash Kumar, Noida (IN); Kush Pandey, Aligarh (IN); Ankit Prabhakar Deogirikar, Bengaluru (IN)

(21) Appl. No.: 18/788,517

(22) Filed: Jul. 30, 2024

(51) Int. Cl. G06T 7/181; G06T 7/11; G06T 7/13; G06T 7/194; G06T 7/50

(52) U.S. Cl. CPC G06T 7/181; G06T 7/11; G06T 7/13; G06T 7/194; G06T 7/50; G06T 2207/10024; G06T 2207/20021

(57) ABSTRACT

The present disclosure relates to systems, non-transitory computer-readable media, and methods for detecting and tracing ridges in digital images using a ridge detection process that includes a depth-first traversal algorithm. For example, the disclosed systems determine, for a digital image, a distance transform defining distances of foreground pixels from background pixels depicted in the digital image. In some embodiments, the disclosed systems generate a preliminary ridge for the digital image by using a depth-first traversal starting at an initial pixel indicated by the distance transform and growing based on local distance transform comparisons among the foreground pixels of the digital image. In certain embodiments, the disclosed systems also generate a final ridge from the preliminary ridge by removing spurious pixels included in ridge flares.

### BACKGROUND

Image skeletonization or thinning is a widely used technique in vectorization, shape recognition, pattern analysis, and other image processing domains. Many existing iterative and geometrical thinning systems have advanced skeletonization technology through functions such as morphological thinning and successive erosion using high order transformations. While existing systems provide some limited skeletonization tools, these systems exhibit a number of technical deficiencies, especially regarding speed and accuracy in extracting or determining precise ridges or skeletons from digital images.

### SUMMARY

Embodiments of the present disclosure provide benefits and/or solve one or more of the foregoing or other problems in the art with systems, non-transitory computer-readable media, and methods for detecting and tracing ridges in digital images using a ridge extraction process that involves a depth-first traversal algorithm. For example, the advanced ridge extraction process of the disclosed systems extracts precise ridges that are continuous and uniform in width. In some embodiments, the ridge extraction process involves segmenting images into color-specific regions, converting the regions into black-and-white, and applying a depth transform to the regions. In one or more embodiments, the disclosed systems also use a depth-first traversal process to build a ridge from depth transforms, starting at an initial pixel and growing according to local pixel comparisons. In some cases, the disclosed systems further clean up a ridge by identifying and suppressing flares. Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates an example system environment in which a ridge extraction system operates in accordance with one or more embodiments.

FIG. 2 illustrates an example overview of extracting a ridge from a digital image and generating a vector path from the ridge in accordance with one or more embodiments.

FIG. 3 illustrates an example of segmenting a digital image into regions and converting regions to black-and-white in accordance with one or more embodiments.

FIG. 4 illustrates an example process of generating a distance transform for a digital image or a region in accordance with one or more embodiments.

FIG. 5 illustrates an example process of applying a depth-first traversal algorithm to generate a preliminary ridge in accordance with one or more embodiments.

FIG. 6 illustrates an example process of generating a final ridge by removing ridge flares in accordance with one or more embodiments.

FIGS. 7A-7D illustrate example comparisons of vector images generated by the ridge extraction system and prior systems in accordance with one or more embodiments.

FIG. 8 illustrates an example schematic diagram for a ridge extraction system in accordance with one or more embodiments.

FIG. 9 illustrates an example series of acts for generating a ridge from a digital image and converting the ridge into a vector path in accordance with one or more embodiments.

FIG. 10 illustrates a block diagram of an example computing device for implementing one or more embodiments of the present disclosure.

### DETAILED DESCRIPTION

This disclosure describes one or more embodiments of a ridge extraction system that extracts or generates ridges from digital images using an advanced ridge extraction process that involves a depth-first traversal algorithm. As suggested, image skeletonization has many uses in 2D and 3D image processing, including handwriting recognition, pattern matching, and bubble chamber analysis. To skeletonize a digital image, in some embodiments, the ridge extraction system segments the digital image into regions by isolating regions depicting different colors. In addition, in some embodiments, the ridge extraction system converts the regions to black-and-white representations and applies a distance transform function to the regions to generate region-specific distance transforms indicating distances of foreground pixels from nearest background pixels. In some cases, the ridge extraction system further utilizes a depth-first traversal algorithm to generate a preliminary ridge by identifying an initial seed pixel for starting a ridge and growing the ridge from the seed pixel according to comparisons of distance transform values. Further, in some embodiments, the ridge extraction system generates a final ridge from the preliminary ridge by identifying and removing or suppressing flares within the preliminary ridge

As just mentioned, in some embodiments, the ridge extraction system generates distance transforms of a digital image as a basis for skeletonizing the digital image. For example, the ridge extraction system applies a distance transform to a digital image to indicate distances of foreground pixels from nearest background pixels (and assigning distance transform values to the foreground pixels). In some cases, the ridge extraction system segments a digital image into color-specific segments using a segmentation neural network and further converts the regions into black-and-white versions as the foundation for applying the distance transform. Indeed, in certain embodiments, the ridge extraction system applies a distance transform to each black-and-white region to determine and assign distance transform values to pixels in the regions.

As also mentioned, in one or more embodiments, the ridge extraction system generates or extracts a preliminary ridge from a distance transform and/or from distance transform values. For instance, the ridge extraction system utilizes a depth-first traversal algorithm to generate a preliminary ridge from an image or a region. In some cases, the depth-first traversal algorithm involves determining or identifying an initial seed pixel for initializing the preliminary ridge. For instance, the ridge extraction system determines a global maximum pixel (e.g., a pixel in the image or region with a highest distance transform value) as an initial pixel for a preliminary ridge and further grows the preliminary ridge from the initial pixel by performing comparisons of distance transform values associated with additional pixels. In some embodiments, the ridge extraction system performs the comparisons using a four-way local maxima test on each successive pixel added to the preliminary ridge to identify and local maxima pixels. In certain cases, the depth-first traversal algorithm involves performing the comparisons and adding pixels to a stack according to a discovery direction along the preliminary ridge. Additional detail regarding the depth-first traversal algorithm is provided below with reference to the figures.

From the preliminary ridge, in some embodiments, the ridge extraction system further generates or extracts a final ridge for a digital image or a region. For instance, the ridge extraction system identifies and suppresses ridge flares that occur within the preliminary ridge. In some cases, the ridge extraction system identifies a flare occurring at a junction or an endpoint of the preliminary ridge, where the flare is made up of spurious pixels protruding orthogonally from the endpoint or junction (and not intended as part of an image skeleton). The ridge extraction system further suppresses or removes the flares based on determining that points or pixels along the flare share a common nearest background pixel. In some embodiments, the ridge extraction system further uses a curve fitting function to generate a vector path or a vector image from the final ridge, thus converting the initial digital image (e.g., a raster image) into a vector image (e.g., a vectorized version of a text character) reflecting an image skeleton.

As suggested above, many conventional systems exhibit a number of shortcomings or disadvantages, particularly in accurately and efficiently extracting ridges or skeletons from digital images. To elaborate, many existing systems determine or extract inaccurate and/or incomplete ridges from digital images. Most existing systems generate ridges that include many imperfections, such as non-uniform width (e.g., thick in some places and thin in others), undesired gaps or holes that break up what should be a continuous ridge, depressions at junctions where a ridge forks into branches, unclear junctions or endpoints, and other flaws. Indeed, the processes of existing systems that involve morphological thinning and successive erosion through high order transformations are prone to producing unwanted artifacts that result in such flaws.

In addition to their inaccuracies, many prior systems are also inefficient. For example, some existing systems consume excessive computer memory and storage by employing slow, inefficient ridge extraction algorithms. Indeed, the iterative nature of many prior systems (e.g., morphological thinning and successive erosion) not only makes deciphering accurate line width difficult, but also results in slow computational speed. As a further contributor to the slow speed and computationally intensive nature of prior systems, many such systems process ridges with high pixel density (which may also vary). Processing higher pixel densities increases compute costs and slows down not only the ridge extraction process but also downstream processes that rely on extracted ridges.

As suggested above, embodiments of the ridge extraction system provide certain improvements or advantages over conventional systems. For example, embodiments of the ridge extraction system improve accuracy in generating or extracting ridges from digital images. Embodiments of the ridge extraction system exhibit such accuracy improvements due to an advanced ridge extraction process that includes a depth-first traversal algorithm for depth transforms. Indeed, the ridge extraction system generates a preliminary ridge by applying a depth transform function to a digital image (or a region) and by further growing the ridge starting from an initial pixel indicated by the depth transform. Through the depth-first traversal, the ridge extraction system produces a continuous ridge without drops or gaps, where the ridge is uniformly one pixel wide and includes precise junctions. The ridge extraction system additionally utilizes a flare suppression process to identify and suppress ridge flares, thereby producing a final ridge without spurious pixels. By implementing these processes and algorithms, the ridge extraction system thus generates accurate, high quality ridges from digital images.

Due at least in part to improving accuracy over prior systems, embodiments of the ridge extraction system also improve speed and efficiency over prior systems. For instance, by keeping ridge width minimal (e.g., one pixel at all points), the ridge extraction system reduces pixel density. With reduced pixel density, the ridge extraction system thus reduces the computational burden of extracting and processing the ridge, as compared to prior systems with higher ridge pixel densities. Experimenters have demonstrated that the ridge extraction system is able to extract a ridge from a 4K image in less than 70 ms, with times around 10 ms for smaller HD images, much faster than prior systems. Such computational improvements are also extended to downstream processes that rely on an extracted ridge.

In addition to improving accuracy and efficiency, embodiments of the ridge extraction system also provide improved flexibility. Indeed, beyond improving image skeletonization, the ridge extraction system also provides tools for vectorizing an image skeleton. Indeed, the ridge extraction system utilizes a curve fitting function to trace a ridge extracted from a digital image, thus generating a vector path version of the image (e.g., a glyph or character). Prior systems are incapable of producing strokes from an input image. As another element of added flexibility, the ridge extraction system is invariant to the rotation of the input image. As opposed to some prior systems that generate different ridges depending on the orientation or rotation of the input image, the ridge extraction system uses an advanced ridge extraction process that is largely invariant and adaptable to changes in rotation.

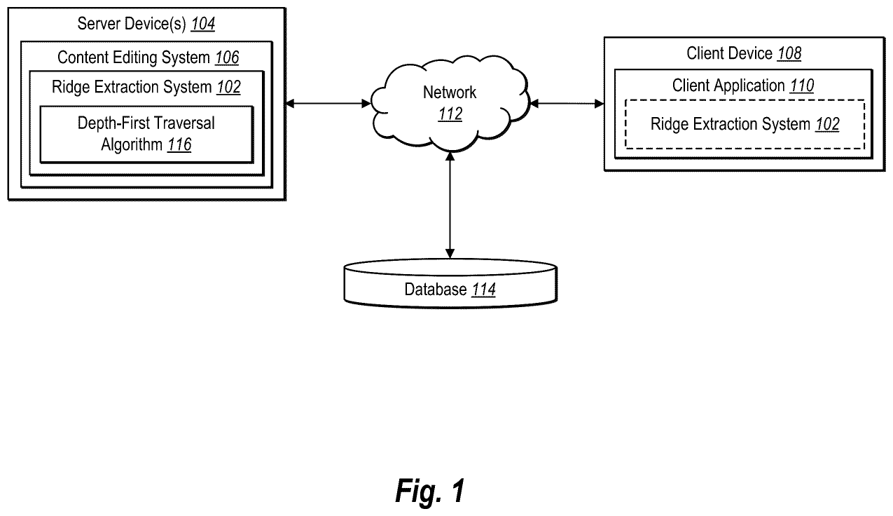

Additional detail regarding the ridge extraction system will now be provided with reference to the figures. For example, FIG. 1 illustrates a schematic diagram of an example system environment for implementing a ridge extraction system 102 in accordance with one or more embodiments. An overview of the ridge extraction system 102 is described in relation to FIG. 1. Thereafter, a more detailed description of the components and processes of the ridge extraction system 102 is provided in relation to the subsequent figures.

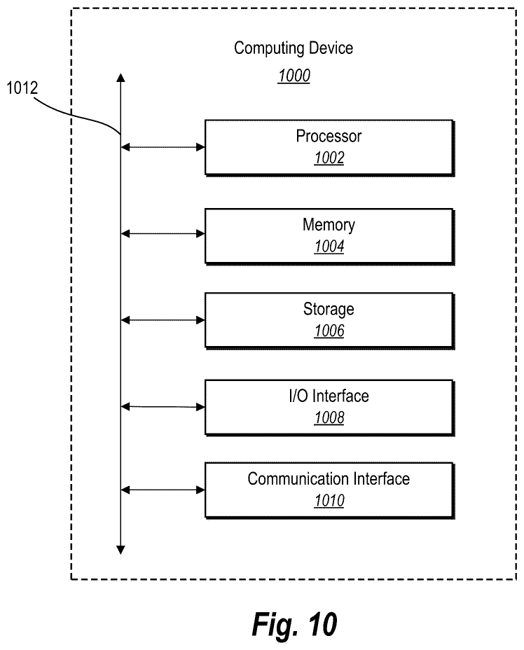

As shown, the environment includes server device(s) 104, a client device 108, a database 114, and a network 112. Each of the components of the environment communicate via the network 112, and the network 112 is any suitable network over which computing devices communicate. Example networks are discussed in more detail below in relation to FIG. 10.

As mentioned, the environment includes a client device 108. The client device 108 is one of a variety of computing devices, including a smartphone, a tablet, a smart television, a desktop computer, a laptop computer, a virtual reality device, an augmented reality device, or another computing device as described in relation to FIG. 10. Although FIG. 1 illustrates a single instance of the client device 108, in some embodiments, the environment includes multiple different client devices, each associated with a different user. The client device 108 communicates with the server device(s) 104 and/or the content editing system 106 via network 112. For example, the client device 108 receives information from the server device(s) 104 and provides information to server device(s) 104 relating to digital images, extracted ridges, and/or generated vector paths.

As shown in FIG. 1, the client device 108 includes a client application 110. In particular, the client application 110 is a web application, a native application installed on the client device 108 (e.g., a mobile application or a desktop application), or a cloud-based application where all or part of the functionality is performed by the server device(s) 104. The client application 110 presents or displays information to a user, including a content editing interface for using ridge extraction tools and/or tracing tools to detect, modify, and/or generate ridges from a digital image, such as a glyph image or some other graphic.

As also illustrated in FIG. 1, the environment includes the server device(s) 104. The server device(s) 104 generates, tracks, stores, processes, receives, and transmits electronic data, such as digital images (e.g., raster images and vector images), depth transform data, extracted ridges, and/or vector data for traced paths. For example, the server device(s) 104 receives data from the client device 108 in the form of a digital image and an indication to extract a ridge. In response, the server device(s) 104 provides data to the client device 108 in the form of a (vectorized version of) a ridge extracted from the digital image, as described herein. For example, the server device(s) 104 communicate with the database 114 to access a depth-first traversal algorithm 116 as part of the ridge extraction process.

In some embodiments, the server device(s) 104 communicates with the client device 108 to transmit and/or receive data via the network 112. In some embodiments, the server device(s) 104 comprises a distributed server where the server device(s) 104 includes a number of server devices distributed across the network 112 and located in different physical locations. The server device(s) 104 comprise a content server, an application server, a communication server, a web-hosting server, a multidimensional server, or a machine learning server.

As further shown in FIG. 1, the server device(s) 104 also includes the ridge extraction system 102 as part of a content editing system 106. For example, in one or more implementations, the content editing system 106 stores, generates, modifies, edits, enhances, provides, distributes, and/or shares digital content, such as digital images. For example, the content editing system 106 provides digital content for editing or other forms of digital processing. In some implementations, the content editing system 106 provides digital content to particular digital profiles associated with client devices (e.g., the client device 108).

In one or more embodiments, the server device(s) 104 includes all, or a portion of, the ridge extraction system 102. For example, the ridge extraction system 102 operates on the server device(s) 104 to extract ridges and/or convert raster images into vector images through tracing detected edges with a curve fitting function. In some embodiments, the client device 108 includes all or part of the ridge extraction system 102. For example, the client device 108 generates, obtains (e.g., downloads), or uses one or more aspects of the ridge extraction system 102, such as the depth-first traversal algorithm 116, a segmentation neural network, a depth transform function, and/or a curve fitting function. Indeed, in some implementations, as illustrated in FIG. 1, the ridge extraction system 102 is located in whole or in part of the client device 108 (e.g., as part of the client application 110). For example, the ridge extraction system 102 includes a web hosting application that allows the client device 108 to interact with the server device(s) 104. To illustrate, in one or more implementations, the client device 108 accesses a web page supported and/or hosted by the server device(s) 104.

In one or more embodiments, the client device 108 and the server device(s) 104 work together to train and/or implement models of the ridge extraction system 102. For example, in some embodiments, the server device(s) 104 train one or more neural networks (e.g., a segmentation neural network) and provide the one or more neural networks to the client device 108 for implementation. In some embodiments, the server device(s) 104 trains one or more neural networks together with the client device 108.

Although FIG. 1 illustrates a particular arrangement of the environment, in some embodiments, the environment has a different arrangement of components and/or may have a different number or set of components altogether. For instance, as mentioned, the ridge extraction system 102 is implemented by (e.g., located entirely or in part on) the client device 108. As another example, the depth-first traversal algorithm 116, a depth transform function, and/or a segmentation neural network are stored in the database 114. In addition, in one or more embodiments, the client device 108 communicates directly with the ridge extraction system 102, bypassing the network 112.

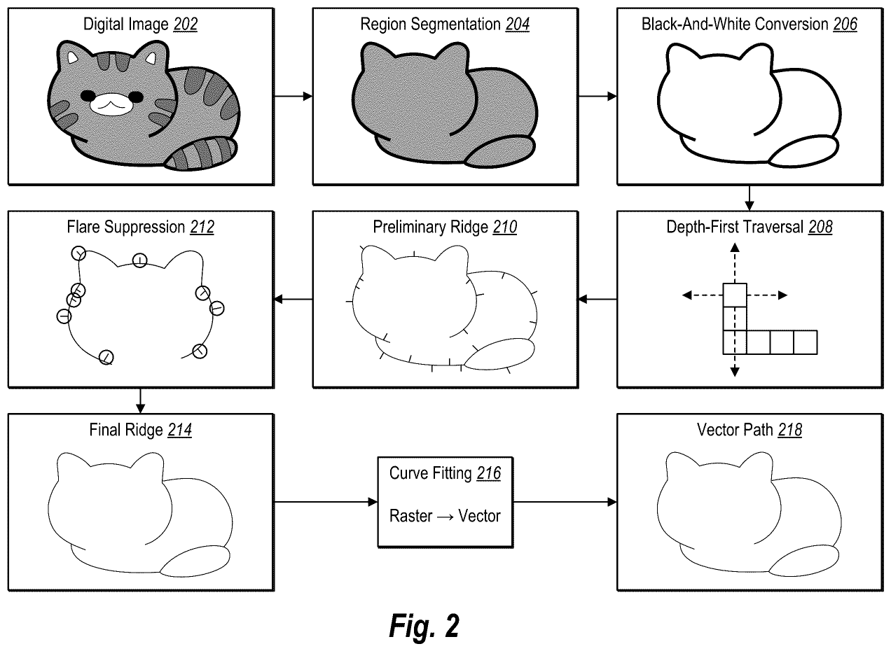

As mentioned, in one or more embodiments, the ridge extraction system 102 skeletonizes a digital image by extracting a ridge. In particular, the ridge extraction system 102 utilizes a ridge extraction process that includes a depth-first traversal algorithm to extract a ridge from a digital image. In addition, the ridge extraction system 102 performs downstream processes on the extracted ridge to, for instance, vectorize the ridge into a vector path or a vector image. FIG. 2 illustrates an example overview of extracting a ridge from a digital image and generating a vector path from the ridge in accordance with one or more embodiments. Additional detail regarding the various acts and processes introduced in relation to FIG. 2 is provided thereafter with reference to subsequent figures.

As illustrated in FIG. 2, the ridge extraction system 102 identifies or receives a digital image 202. In particular, the ridge extraction system 102 receives the digital image 202 as an upload from a client device (e.g., the client device 108), as a selection from a digital image repository, or as a generated image drawn via a client device using an image editing application (e.g., as part of the content editing system 106). In some cases, the digital image 202 is a raster image while in other cases the digital image 202 is a vector image. As shown, the digital image 202 is a cartoon cat with rounded features.

As also illustrated in FIG. 2, the ridge extraction system 102 performs a region segmentation 204. More particularly, the ridge extraction system 102 performs the region segmentation 204 as part of a ridge extraction process. For example, a ridge includes or refers to a thinned skeleton or outline of an image or a region defining or preserving the shape or silhouette of the image structure. In some embodiments, the ridge extraction system 102 performs the region segmentation to separate the digital image 202 into color-specific regions, where each segmented region depicts pixels of a common color or within a range of pixel values (e.g., RGB values). In some cases, the ridge extraction system 102 uses a segmentation neural network to segment the digital image 202 into regions.

In some embodiments, a neural network (e.g., a segmentation neural network) includes or refers to a machine learning model that is trainable and/or tunable based on inputs to generate predictions, determine classifications, or approximate unknown functions. For example, a neural network includes a model of interconnected artificial neurons (e.g., organized in layers) that communicate and learn to approximate complex functions and generate outputs (e.g., image regions) based on a plurality of inputs provided to the neural network. In some cases, a neural network refers to an algorithm (or set of algorithms) that implements deep learning techniques to model high-level abstractions in data. For example, a neural network includes a deep neural network, a convolutional neural network, a recurrent neural network (e.g., an LSTM), a graph neural network, a transformer, or a generative neural network (e.g., a generative adversarial neural network or a diffusion neural network).

As further illustrated in FIG. 2, the ridge extraction system 102 performs a black-and-white conversion 206. To elaborate, the ridge extraction system 102 converts the regions of the digital image 202 (or the digital image 202 itself) to black and white. For example, the ridge extraction system 102 determines or detects foreground pixels and background pixels in an image or a region. In addition, the ridge extraction system 102 converts foreground pixels to white and background pixels to black (or vice-versa). In some embodiments, the ridge extraction system 102 differentiates between foreground and background pixels without needing to convert to black and white. For instance, the ridge extraction system 102 uses a segmentation model to label foreground and background pixels or the ridge extraction system 102 uses a foreground mask to mask background or foreground pixels.

Additionally, the ridge extraction system 102 performs a depth-first traversal 208. In particular, the ridge extraction system 102 uses a depth-first traversal algorithm to traverse a black-and-white region or image for generating a preliminary ridge. In some embodiments, the ridge extraction system 102 performs the depth-first traversal 208 on the digital image 202 (e.g., without the region segmentation 204 and/or the black-and-white conversion 206).

As part of, or as a preliminary step to, the depth-first traversal 208, the ridge extraction system 102 generates a depth transform of a region or a digital image. For example, a depth transform includes or refers to a transformed version of a region or a digital image where foreground pixels are assigned depth transform values indicated respective distances to nearest background pixels. In some embodiments, the ridge extraction system 102 uses a depth transform function to generate a depth transform that indicates distances of foreground pixels from nearest background pixels. In some cases, the ridge extraction system 102 generates a depth transform for a particular black-and-white region or black-and-white image. In generating the depth transform, the ridge extraction system 102 generates and assigns depth transform values to foreground pixels. For instance, the ridge extraction system 102 determines a pixel distance of a foreground pixel to its nearest background pixel and assigns the pixel distance to the foreground pixel as its distance transform value.

From the depth transform of a region or an image, the ridge extraction system 102 further applies the depth-first traversal 208. As part of this process, the ridge extraction system 102 identifies or determines an initial seed pixel from the depth transform, and the ridge extraction system 102 grows the preliminary ridge from the initial pixel. For instance, the ridge extraction system 102 determines a global maximum pixel as a foreground pixel with a highest distance transform value, or a farthest distance from the nearest background pixel. From the initial pixel, the ridge extraction system 102 identifies or determines additional pixels to add to the ridge, such as local maxima (e.g., pixels with local maximum distance transform values), using a four-way local maxima test. In some cases, the ridge extraction system 102 processes pixels in a particular order based on a discovery direction to prevent zig zags or jagged regions in ridges. For example, a discovery direction includes or refers to a direction from a previously identified/selected pixel to a next candidate pixel for testing as part of a ridge.

As further illustrated in FIG. 2, the ridge extraction system 102 generates a preliminary ridge 210 from the depth-first traversal 208. More specifically, the ridge extraction system 102 generates a preliminary ridge by adding pixels one by one starting from the initial pixel. The ridge extraction system 102 thus grows the preliminary ridge 210 to include pixels that pass four-way local maxima tests (e.g., tested along the four possible normal directions of a given pixel) and which are processed from a stack built based on the discovery direction. Additional detail regarding generating preliminary ridges is provided below. As shown, the preliminary ridge 210 includes or depicts spurious pixels in the form of ridge flares that extend in normal directions (or perpendicular or orthogonal to the ridge).

To remedy the issue of the ridge flares, as shown in FIG. 2, the ridge extraction system 102 performs a flare suppression 212. In particular, the ridge extraction system 102 identifies ridge flares by performing a flare test or a flare detection based on comparing nearest background pixels. In some cases, a ridge flare includes or refers to a set of one or more pixels that are spurious or extraneous and that do not reflect an actual ridge or skeleton of a digital image. The ridge extraction system 102 removes or suppresses a ridge flare by removing pixels along a branch of a ridge where all pixels of the branch share a common nearest background pixel (because nearest background pixels should change when progressing along pixels of the ridge).

As further illustrated in FIG. 2, the ridge extraction system 102 generates a final ridge 214. Indeed, the ridge extraction system 102 generates the final ridge 214 without ridge flares. As shown, the final ridge 214 is continuous (without holes or breaks), uniform (e.g., one pixel wide at all locations), shows precise junctions and endpoints, and includes no flares. By performing the depth-first traversal 208 and the flare suppression 212, the ridge extraction system 102 generates the final ridge 214 that is accurate and precise, using techniques that are invariant to rotation, translation, and scaling, and that improve or ensure continuity and uniformity.

As shown, ridge extraction system 102 also performs a curve fitting 216. In particular, the ridge extraction system 102 uses a curve fitting function to trace or vectorize the final ridge 214. The ridge extraction system 102 thus generates a vector path 218 as a vectorized version of the final ridge 214, defining a vector image of Bezier curves or splines that are editable and manipulable in downstream applications.

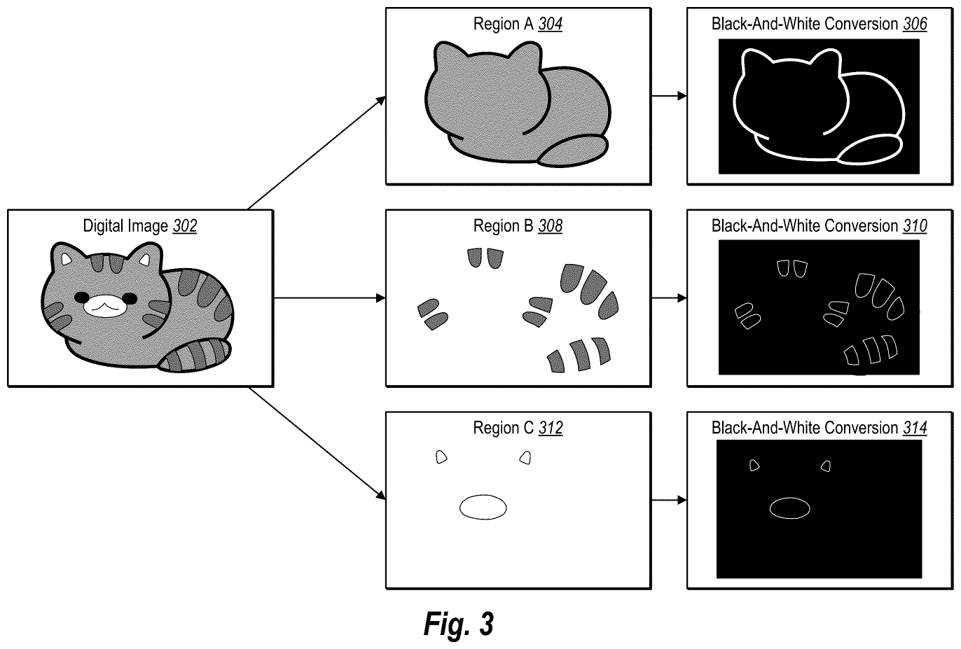

As noted above, in certain described embodiments, the ridge extraction system 102 segments a digital image. In particular, the ridge extraction system 102 utilizes a segmentation neural network to segment a digital image into color-specific regions as a basis for extracting a ridge or skeleton. In addition, the ridge extraction system 102 converts image regions into black-and-white versions depicted foreground and background pixels. FIG. 3 illustrates an example process of segmenting and converting regions of a digital image in accordance with one or more embodiments.

As illustrated in FIG. 3, the ridge extraction system 102 generates or segments regions from a digital image 302. In some embodiments, the ridge extraction system 102 generates strokes (e.g., vector paths) from a digital image. Because strokes are constant color and uniform width, in some embodiments, different colored regions and/or regions of different widths cannot be represented by a single stroke. Accordingly, the ridge extraction system 102 segments the digital image 302 to isolate color-specific regions, where each region depicts pixels within a particular color range (e.g., a range of RGB values). For instance, the ridge extraction system 102 segments the digital image 302 into Region A 304, Region B 308, and Region C 312 using a segmentation neural network. Indeed, the segmentation neural network processes the pixels of the digital image 302 to generate the different regions that each depict groups of pixels sharing a common color (or range of pixel values). In one or more embodiments, the ridge extraction system 102 quantizes the digital image 302 before segmentation to prevent or reduce artifacts that might result from noise introduced by a segmentation neural network. By co-placing visually similar (e.g., within a threshold range of RGB values) pixels together, the quantization of the ridge extraction system 102 also reduces the number of output regions.

As also illustrated in FIG. 3, the ridge extraction system 102 converts the regions into black-and-white. To elaborate, the ridge extraction system 102 generates a black-and-white conversion 306 from Region A 304, generates a black-and-white conversion 310 from the Region B 308, and generates a black-and-white conversion 314 from the Region C 312. To convert a region to black-and-white, the ridge extraction system 102 identifies or determines foreground pixels (e.g., pixels depicting prominent objects and/or focus elements) and background pixels (e.g., pixels depicting backdrops, canvases behind objects, and/or non-focus elements). The ridge extraction system 102 further converts the foreground pixels to white and the background pixels to black.

Not all regions are made up of or include strokes. Accordingly, the ridge extraction system 102 utilizes additional steps of a ridge extraction process, such as a distance transform function and a depth-first traversal algorithm, to determine which regions include strokes. The ridge extraction system 102 thus extracts ridges from such regions and converts the ridges into vector paths or strokes using a curve fitting function, as described in more detail hereafter.

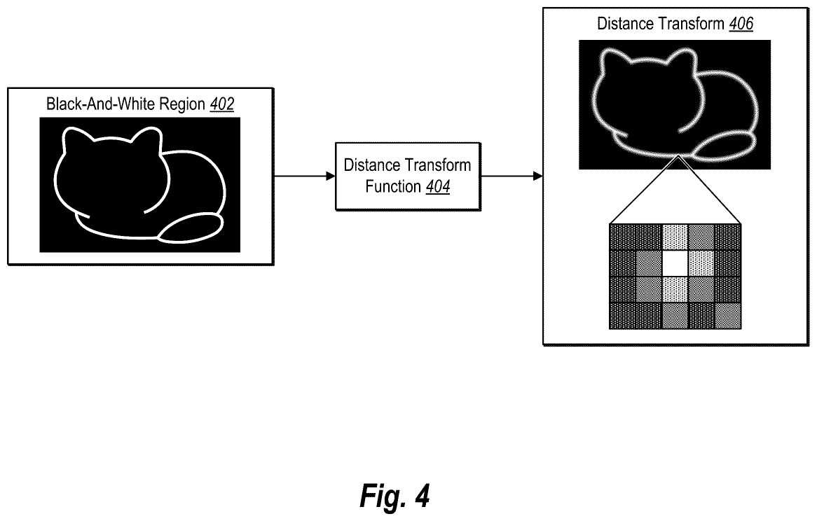

As mentioned above, in one or more embodiments, the ridge extraction system 102 generates a ridge from a black-and-white version of a digital image or region. In particular, the ridge extraction system 102 generates a ridge as a basis for vector stroke or vector path reconstruction of a digital image. FIG. 4 illustrates an example process of using a distance transform function to generate a distance transform as part of a ridge extraction process in accordance with one or more embodiments.

As illustrated in FIG. 4, the ridge extraction system 102 identifies a black-and-white region 402. For instance, the ridge extraction system 102 identifies a region segmented and converted as described above in relation to FIG. 3. In addition, the ridge extraction system 102 utilizes a distance transform function 404 to generate a distance transform 406 from the black-and-white region 402. In some cases, the ridge extraction system 102 utilizes the distance transform function 404 to generate distance transform from a non black-and-white region and/or from a digital image.

In applying the distance transform function, the ridge extraction system 102 determines distances of foreground (e.g., white) pixels from background (e.g., black pixels). More specifically, the ridge extraction system 102 determines, for each foreground pixel in the black-and-white region 402, a distance (in pixels and/or pixel fractions) of the foreground pixel from a nearest background pixel. In some cases, the ridge extraction system 102 utilizes a distance transform function 404 in the form of a Euclidean distance transform function to determine Euclidean distances of foreground pixels from nearest background pixels. As part of the distance transform function 404, the ridge extraction system 102 further generates a mapping of each foreground pixel to its closest background pixel (or boundary pixel). As discussed in further detail below, the ridge extraction system 102 uses this mapping for corner detection and flare suppression.

As shown, the ridge extraction system 102 generates the distance transform 406 using the distance transform function 404 on the black-and-white region 402. Indeed, the distance transform 406 indicates distance transform values for foreground pixels. As shown, the lighter colored pixels in the zoomed-in window indicate higher distance transform values farther from the nearest background pixel. As the pixels get darker (or more densely patterned), the distance transform values decrease with smaller distances to nearest background pixels. In some cases, foreground pixels immediately adjacent to (or touching) a background pixel have a unit distance of one pixel. Background pixels have distance transform values of zero.

Because pixels are rectangular units with dimensions, and not mathematical points, certain imperfections are present in the distance transform 406, including incorrect indications of highest distance transform values that result in faulty branches or spurious pixels. Such imperfections are even more prevalent in image with anti-aliasing effects and/or noise artifacts. To fix these imperfections and generate an accurate, precise ridge, the ridge extraction system 102 thus uses a depth-first traversal algorithm that accounts for the imperfections in the distance transform (which the heuristics of prior systems do not account for).

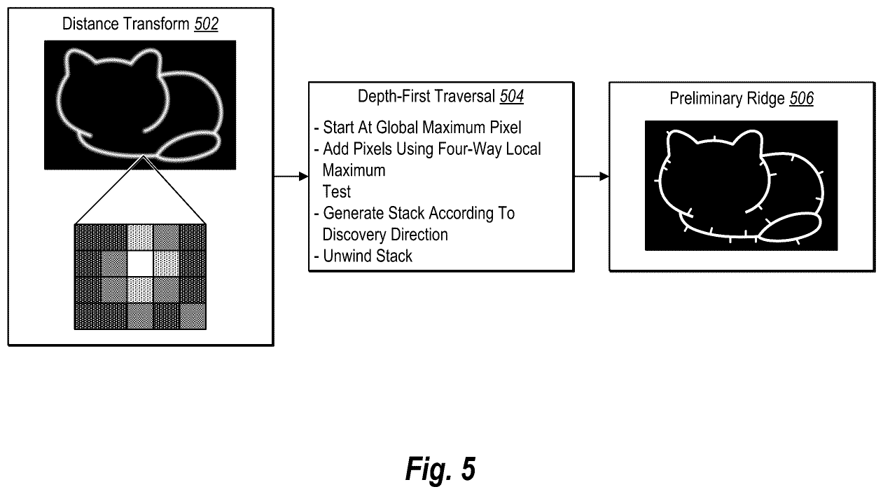

As just indicated, the ridge extraction system 102 fixes or remedies imperfections that might otherwise result from pixel-based distance transforms. In particular, the ridge extraction system 102 uses a depth-first traversal algorithm to generate a preliminary ridge from a depth transform of a digital image or a region. FIG. 5 illustrates an example diagram for using a depth-first traversal algorithm to generate a preliminary ridge in accordance with one or more embodiments.

As illustrated in FIG. 5, the ridge extraction system 102 identifies or generates a distance transform 502. Indeed, as described, the ridge extraction system 102 generates the distance transform 502 using a distance transform function to assign distance transform values to foreground pixels of a digital image or a region. The ridge extraction system 102 further performs a depth-first traversal 504 on the distance transform 502. Because of the uncertainties introduced by the dimensionality of pixels in digital images (rather than mathematical points), the ridge extraction system 102 determines that the distance transform value for a given ridge pixel is not smaller than its adjacent pixels in the distance transform 502 (whereas mathematical points would result in a guarantee of ridge pixel values being higher).

As part of the depth-first traversal 504 for resolving such uncertainties, the ridge extraction system 102 identifies an initial seed pixel for starting a preliminary ridge. To elaborate, the ridge extraction system 102 identifies or determines a pixel with a highest or maximum distance transform value within the distance transform 502. The ridge extraction system 102 designates this pixel as a global maximum for seeding expansion of the preliminary ridge 506. Indeed, the ridge extraction system 102 analyzes or processes the eight neighboring pixels surrounding the initial (global maximum) pixel to determine which of them to include within the preliminary ridge 506.

To identify pixels for including in, or adding to, the preliminary ridge 506, the ridge extraction system 102 performs a local maxima test. Specifically, the ridge extraction system 102 performs a four-way local maxima test on each of the eight neighboring pixels, comparing the distance transform values of the target pixel with adjacent pixels in each of the four normal directions from the target pixel. The ridge extraction system 102 designates or identifies a pixel as a local maximum pixel to add to the preliminary ridge 506 if one or more of the tested directions pass the local maxima test.

Specifically, the ridge extraction system 102 performs a local maxima test to compare pixels (e.g., a target pixel and its neighbors along normal directions) by comparing distance transform values of the pixels with a one-pixel lookahead. For the one-pixel lookahead, in case a distance transform value of a target pixel is equal to (or within a threshold difference of) that of one or more adjacent pixels, the ridge extraction system 102 compares the next adjacent pixel along the same normal direction (as the compared pixel that is equal to the target pixel). This four-way local maxima test makes the ridge extraction system 102 largely invariant to the angle of rotation of the initial digital image and resolves the problem of the normal direction to the ridge being unknown.

Accordingly, the ridge extraction system 102 starts at the initial (global maximum) pixel and grows the preliminary ridge 506 using the four-way local maxima test to add pixels. As part of this process, the ridge extraction system 102 tests each of the foreground pixels (excluding the background pixels for increased computational efficiency) in the distance transform 502 once. Indeed, if a foreground pixel neighbors more than one other foreground pixel, the ridge extraction system 102 does not re-process the pixel on the second encounter.

To facilitate one-time processing of foreground pixels as part of the depth-first traversal 504, the ridge extraction system 102 generates and maintains a pixel stack. The ridge extraction system 102 adds pixels to the stack in an order or sequence for performing four-way local maxima tests for inclusion in the preliminary ridge 506. To prevent zig-zag patterns in the preliminary ridge 506 that might otherwise result in testing the eight neighboring pixels in a random order, the ridge extraction system 102 generates the stack according to a discovery direction of a target pixel.

For example, the ridge extraction system 102 determines a discovery direction of a target pixel as a direction along the preliminary ridge 506 traversed to process the target pixel. The ridge extraction system 102 further determines a deviation from the discovery direction for each of the eight neighboring pixels of the target pixel. For instance, the ridge extraction system 102 determines a deviation in units (e.g., pixels) from the discovery direction, where a top-left neighboring pixel is a deviation of one from a left neighboring pixel, and a top-left pixel is a deviation of two from a bottom-right pixel. For each target pixel tested for inclusion in the preliminary ridge 506, the ridge extraction system 102 orders its neighboring pixels within the stack by adding those with the largest deviation from the discovery direction to the stack first and those with the smallest deviation last (or vice-versa in some embodiments).

The ridge extraction system 102 further unwinds the stack by accessing and processing the first pixel pushed to stack last (e.g., a FILO stack). Thus, when the ridge extraction system 102 processes a pixel in the stack, its neighbors have already been processed. Accordingly, the ridge extraction system 102 processes pixels with the smallest deviation first to determine their neighbors and test whether to add them to the preliminary ridge 506 using a four-way local maxima test. Consequently, the ridge extraction system 102 tests pixels with the largest deviation last. Through this process of performing four-way local maxima tests on pixels based on their deviation from the discovery direction, the ridge extraction system 102 grows the preliminary ridge 506 along the discovery direction, preventing zig zags, and generating a smooth ridge.

As part of unwinding the stack to process pixels, the ridge extraction system 102 maintains minimal width of one pixel along the preliminary ridge 506. To do so, the ridge extraction system 102 removes or prunes extra pixels. To maintain continuity while minimizing ridge width, the ridge extraction system 102 removes or prunes a pixel popped from the stack if its removal results in no loss of contiguity among its neighbors selected for the preliminary ridge 506. The ridge extraction system 102 maintains a pixel as part of the preliminary ridge 506 if removing the pixel would cause a break in contiguity in the preliminary ridge 506. Keeping the count of ridge pixels minimum with the one-pixel width reduces processing time and improves computational efficiency of downstream processes, including curve fitting for generating strokes or vector paths. Doing so also improves precision in identifying junctions, corners, and endpoints.

Through the depth-first traversal 504, the ridge extraction system 102 thus applies a four-way local maxima filter on foreground pixels in the distance transform 502 to generate the preliminary ridge 506, excluding pixels that are not local maxima and including those that are. In some embodiments, as described above, the depth-first traversal 504 provides three improvements (or guarantees) in generating the preliminary ridge 506. First, the preliminary ridge 506 is continuous without gaps or holes. Second, the preliminary ridge 506 is minimal in width at one pixel wide throughout. Third, the preliminary ridge is unidirectional by growing branches as long as possible along discovery directions according to four-way local maxima tests. While the preliminary ridge 506 depicts an outline or a skeleton of the initial digital image or region, the preliminary ridge 506 also includes spurious pixels in flares.

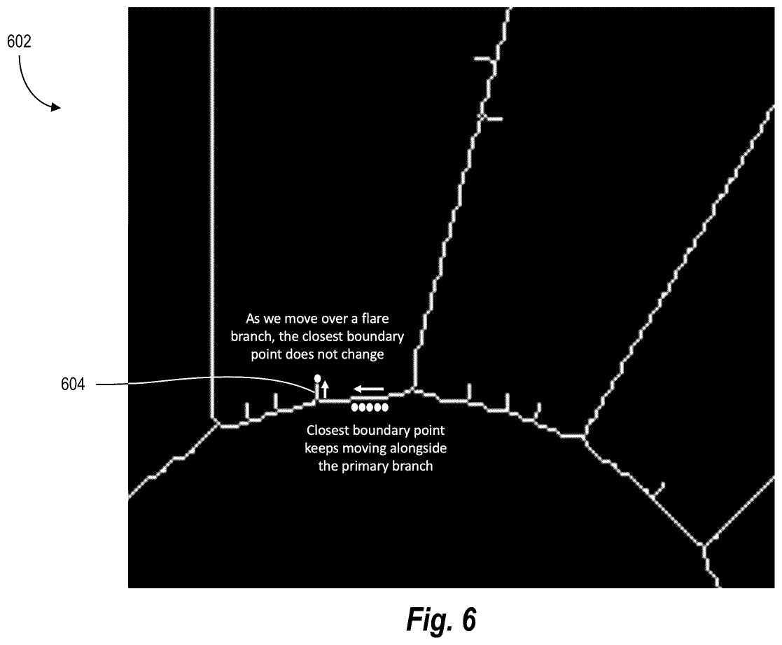

In certain embodiments, the ridge extraction system 102 removes or suppresses flares. In particular, the ridge extraction system 102 removes spurious pixels included in ridge flares by iterating over a preliminary ridge to identify and remove ridge flares according to a nearest background pixel test. FIG. 6 illustrates an example diagram for identifying and removing ridge flares in accordance with one or more embodiments.

As illustrated in FIG. 6, the ridge extraction system 102 iterates over each pixel of a preliminary ridge 602. Throughout the iteration process, the ridge extraction system 102 determines a degree of connectivity for each pixel, defining a number of immediate neighbor pixels (out of a possible eight pixels) that are present in the preliminary ridge 602. While iterating, the ridge extraction system 102 further records logical branches in the preliminary ridge 602, where a branch includes or refers to a longest continuous extension of connected pixels with a degree of connectivity less than or equal to two. In some cases, the ridge extraction system 102 terminates a branch at a pixel with a degree higher than two (e.g., three or more), where such a location is designated or defined as a junction within the preliminary ridge 602 (because they have more than two incident branches). In many cases, branches span between junctions and/or endpoints.

In addition to defining junctions, endpoints, and branches, the ridge extraction system 102 also defines ridge flares, such as the ridge flare 604. To elaborate, the ridge extraction system 102 identifies flares as junctions with three incident branches where one branch having a pixel at the end with a degree of connectivity of one—an endpoint. In addition, the ridge extraction system 102 identifies flares as branches that run in a direction along a normal of a primary branch of the preliminary ridge 602. As noted above, the ridge extraction system 102 maintains a mapping of a nearest background pixel for each foreground pixel. For primary branches (or branches to include along the preliminary ridge 602), each foreground pixel corresponds to its own different nearest background pixel because each nearest background pixel is orthogonal to the backbone of the preliminary ridge 602. Conversely, for ridge flares, each of the foreground pixels shares a common nearest background pixel (or two nearest background pixels).

Accordingly, the ridge extraction system 102 checks pixels of the preliminary ridge 602 to identify branches that share the same one or two nearest background pixel(s). In some embodiment, the ridge extraction system 102 also or alternatively checks whether extending the branch reaches within a threshold pixel distance (e.g., one or two pixels away) from the nearest background pixel (which would never happen along the primary ridge as the nearest background pixels are always orthogonal and would change with each tested pixel). The ridge extraction system 102 thus identifies ridge flares, such as the ridge flare 604 which includes pixels that all share a common nearest background pixel.

In one or more embodiments, the ridge extraction system 102 identifies corners and terminal branches as part of identifying ridge flares. For example, the ridge extraction system 102 distinguishes between flares and non-flare terminals or corners to prevent removing pixels from portions of the preliminary ridge 602 that are not within flares. For terminals, the ridge extraction system 102 identifies one primary incident branch and two protruding (non-primary) branches in the preliminary ridge 602, where the protruding branches terminate on an endpoint with a connectivity degree of one. The ridge extraction system 102 thus distinguishes terminals from flares because flares have two primary incident branches (instead of one) and one protruding branch (instead of two).

For corners, the ridge extraction system 102 identifies two primary incident branches and one protruding branch, the same as for a flare. However, to distinguish a corner from a flare, the ridge extraction system 102 determines that the two primary incident branches form an angle or a bend (rather than a line along a continued path direction, as would be the case for a flare). Because corners can occur between curves and not only between straight lines, in some cases, the ridge extraction system 102 does not determine the angle of the bend directly, but instead determines a change between the angles of normals of the two primary incident branches (e.g., an angle of a first normal from a first-branch pixel to its nearest background pixel and an angle of a second normal from a second-branch pixel to its nearest background pixel). The ridge extraction system 102 thus identifies a flare, such as the ridge flare 604, in cases where both primary branches have the same normal angle (or angles within a threshold different of one another).

The ridge extraction system 102 thus identifies the ridge flare 604 and removes or deletes the pixels included in the ridge flare 604. By thus identifying and removing ridge flares, the ridge extraction system 102 generates a final ridge from the preliminary ridge 602, where the final ridge includes no flares or spurious pixels.

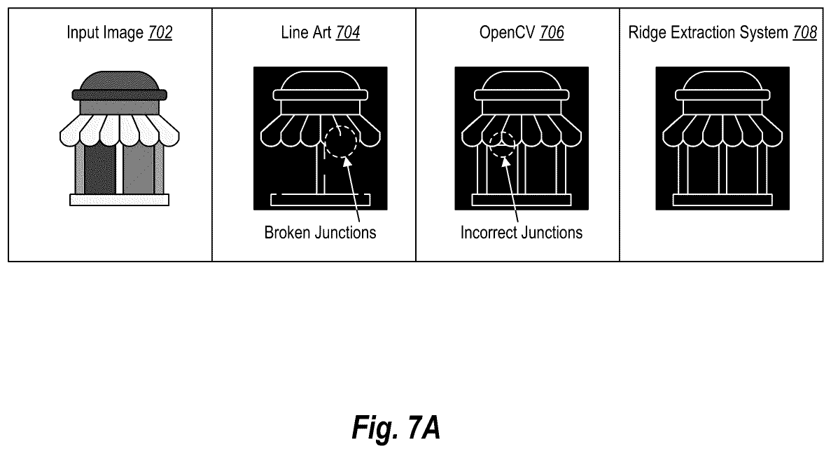

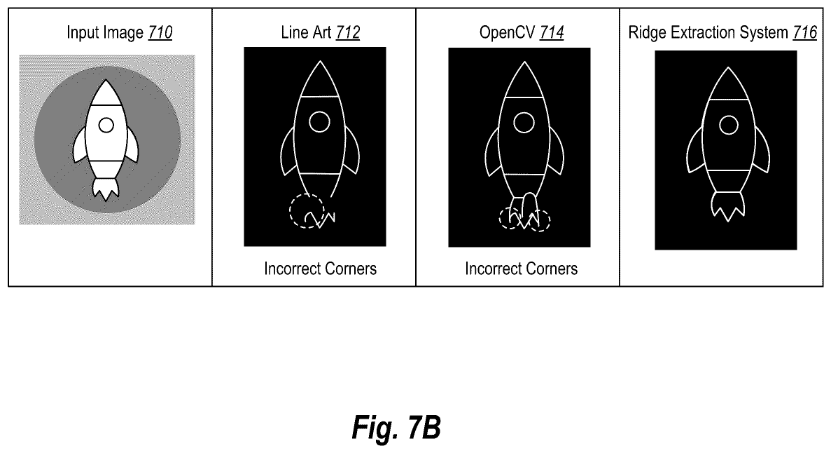

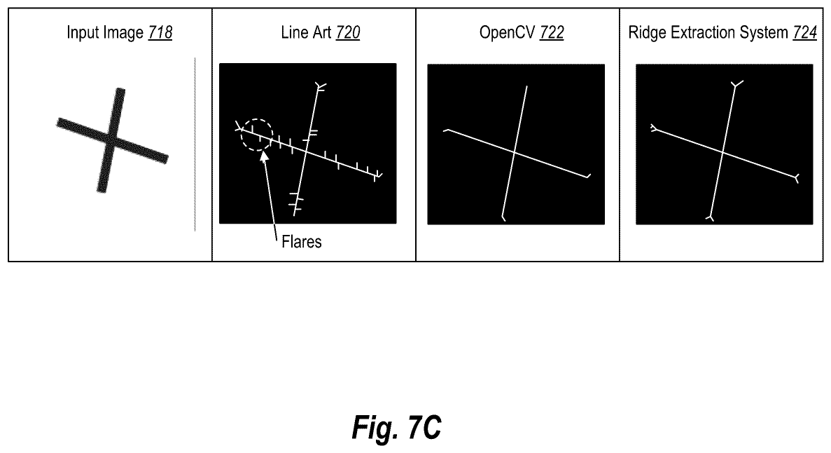

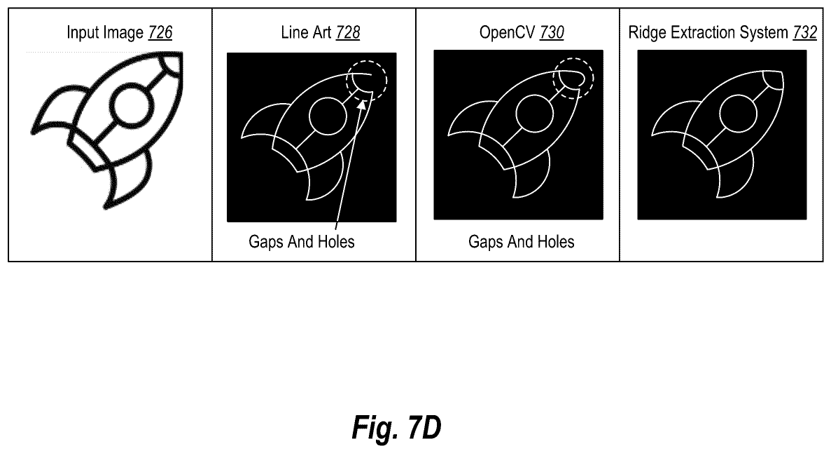

As mentioned above, in certain embodiments, the ridge extraction system 102 generates strokes or vector paths from a final ridge of a digital image. In particular, the ridge extraction system 102 vectorizes a final ridge to generate a vector version of an image skeleton, outlining a graphic such as a glyph or a character. Using the techniques described herein, the ridge extraction system 102 generates more accurate vector paths than prior systems. FIGS. 7A-7D illustrate example comparisons of vector paths generated by the ridge extraction system 102 compared with those of prior systems in accordance with one or more embodiments.

As illustrated in FIG. 7A, the input image 702 is processed by three different systems for vectorization. Specifically, the image 704 is generated by Adobe Illustrator's Line Art model, and the image 706 is generated by an OpenCV model as described by Itseez in The OpenCV Reference Manual, edition 2.4.9.0 (2014). In some cases, the image 704 and the image 706 are vector paths or strokes generated from the input image 702. As shown, the image 704 depicts broken junctions and missing paths or branches. As also shown, the image 706 depicts incorrect junctions with extra paths or branches where they do not belong.

As further illustrated in FIG. 7A, the ridge extraction system 102 generates a vector image 708 that reflects correct junctions without missing paths and without broken junctions. To generate the vector image 708, the ridge extraction system 102 utilizes a curve fitting function to vectorize or trace a final ridge. Indeed, the ridge extraction system 102 generates a final ridge from the input image 702 by executing processes as described above to segment the input image 702, generate a distance transform, perform a depth-first traversal, define corners, branches, and junctions, and remove ridge flares. The ridge extraction system 102 further uses a curve fitting functions to find the least error cubic Bezier curve that fits the pixels on each branch of the final ridge.

The ridge extraction system 102 further determines a width and color for each stroke or path in the vector image 708. The ridge extraction system 102 determines width from the distance transform which measures distance of branch pixels (from which strokes are formed) to closest boundary/background pixels. The ridge extraction system 102 generates a histogram for branch widths at all branch pixels and determines concentrations around different width values. Upon determining at least a threshold concentration of width values for pixels along a branch, the ridge extraction system 102 determines that the region includes a branch to represent with a vector path or a stroke. If no such concentration exists (or it does not satisfy the threshold), the ridge extraction system 102 determines that the underlying region does not represent a stroke vector path and the ridge extraction system 102 instead uses a fill function to fill the region with a color.

To determine the color for a vector path or a stroke (or a fill region), the ridge extraction system 102 looks up color data from the segmentation process. Indeed, as described, the ridge extraction system 102 segments the input image 702 into color-specific regions as part of generating a final ridge. Thus, the ridge extraction system 102 looks up the unique color determined by the segmentation neural network for the region and applies the color to the stroke or the vector path.

Using the width and color data, along with the curve fitting function, the ridge extraction system 102 thus generates the vector image 708. As shown, the vector image 708 is higher quality than the image 704 and the image 706 generated by prior models. Indeed, the vector image 708 includes no broken junctions, no incorrect junctions, and no missing paths or branches.

FIGS. 7B-7D illustrate similar comparisons. For example, FIG. 7B illustrates an input image 710 of a cartoon rocket. From the input image 710, Line Art generates an image 712 (e.g., a vector image) that includes incorrect corners. Similarly, OpenCV generates an image 714 (e.g., a vector image) that includes incorrect corners. The ridge extraction system 102, on the other hand, generates a vector image 716 that does not include incorrect corners and that accurately portrays a vectorized version of the input image 710 after ridge extraction.

FIG. 7C illustrates comparisons for a different circumstance. Specifically, the compared systems generate vector images from an input image 718 that depicts a slanted or tilted “X” or cross. From the input image 718, Line Art generates an image 720 that includes spurious pixels in many different flares throughout. Additionally, OpenCV generates an image 722 that incorrectly generates terminals with only two incident branches (one primary and one protruding). The ridge extraction system 102, however, generates a vector image 724 that does not include flares and that correctly includes three incident branches (one primary and two protruding) for terminals.

FIG. 7D illustrates comparisons of generating outputs from a tilted cartoon rocket. As shown, Line Art processes the input image 726 to generate an image 728 that includes gaps and holes in places. In addition, OpenCV processes the input image 726 to generate an image 730 that also includes gaps or holes. Conversely, the ridge extraction system 102 processes the input image 726 to generate a vector image 732 that accurately skeletonizes the input image 726 without gaps or holes.

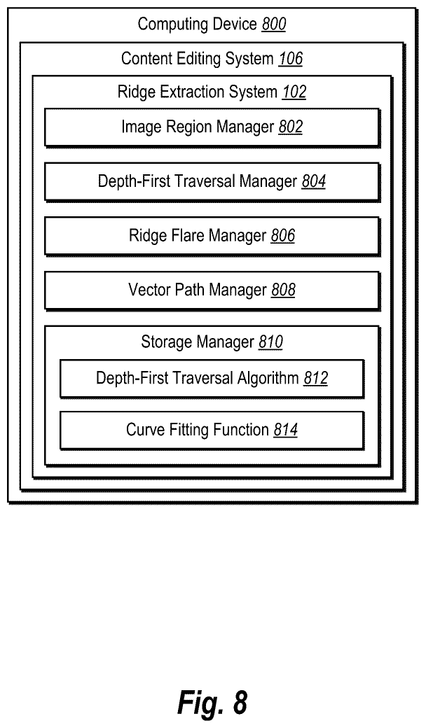

Looking now to FIG. 8, additional detail will be provided regarding components and capabilities of the ridge extraction system 102. Specifically, FIG. 8 illustrates an example schematic diagram of the ridge extraction system 102 on an example computing device 800 (e.g., one or more of the client device 108 and/or the server device(s) 104). In some embodiments, the computing device 800 refers to a distributed computing system where different managers are located on different devices, as described above. As shown in FIG. 8, the ridge extraction system 102 includes an image region manager 802, a depth-first traversal manager 804, a ridge flare manager 806, a vector path manager 808, and a storage manager 810.

As just mentioned, the ridge extraction system 102 includes an image region manager 802. In particular, the image region manager 802 manages, maintains, generates, extracts, segments, or determines image regions from a digital image, such as a raster image. For example, the image region manager 802 utilizes a segmentation neural network to segment a digital image into color-specific regions. In addition, the image region manager 802 converts image regions into black-and-white representations for further downstream processing. In some cases, the image region manager 802 also uses a distance transform function to generate distance transforms for image regions (e.g., the black-and-white versions of the image regions), as described herein.

As shown, the ridge extraction system 102 also includes a depth-first traversal manager 804. In particular, the depth-first traversal manager 804 manages, maintains, implements, processes, applies, or executes a depth-first traversal algorithm. For example, the depth-first traversal manager 804 executes a depth-first traversal algorithm on a digital image or a region to generate or grow a preliminary ridge as described herein.

As also shown, the ridge extraction system 102 includes a ridge flare manager 806. In particular, the ridge flare manager 806 manages, maintains, determines, identifies, removes, suppresses, or deletes ridge flares. For example, the ridge flare manager 806 determines ridge flares that contain spurious pixels, distinguishing flares from other branches of a preliminary ridge, as described herein. The ridge flare manager 806 further removes the ridge flares from the preliminary ridge to generate a final ridge that accurately represents a skeleton or backbone of a digital image or a region.

Additionally, the ridge extraction system 102 includes a vector path manager 808. In particular, the vector path manager 808 manages, maintains, generates, extracts, traces, or converts a vector image from a region or a digital image. For example, the vector path manager 808 uses a curve fitting function to generate a vectorized image or a vector path from a final ridge extracted from a region. The vector path manager 808 further applies color and width to the vector path as described herein.

The ridge extraction system 102 further includes a storage manager 810. The storage manager 810 operates in conjunction with, or includes, one or more memory devices such as a database (e.g., the database 114) that store various data such as raster images, vector images, extracted ridges (including junctions, branches, and terminals), and/or vector paths. As shown, the storage manager 810 stores a depth-first traversal algorithm 812 accessible and usable by other components of the ridge extraction system 102. In some cases, the storage manager 810 also stores a curve fitting function 814 accessible and usable by other components of the ridge extraction system 102. The storage manager 810 communicates with the other components of the ridge extraction system 102 to facilitate the operations and functions described herein.

In one or more embodiments, each of the components of the ridge extraction system 102 are in communication with one another using any suitable communication technologies. Additionally, the components of the ridge extraction system 102 is in communication with one or more other devices including one or more client devices described above. It will be recognized that although the components of the ridge extraction system 102 are shown to be separate in FIG. 8, any of the subcomponents may be combined into fewer components, such as into a single component, or divided into more components as may serve a particular implementation. Furthermore, although the components of FIG. 8 are described in connection with the ridge extraction system 102, at least some of the components for performing operations in conjunction with the ridge extraction system 102 described herein may be implemented on other devices within the environment.

The components of the ridge extraction system 102, in one or more implementations, includes software, hardware, or both. For example, the components of the ridge extraction system 102 include one or more instructions stored on a computer-readable storage medium and executable by processors of one or more computing devices (e.g., the computing device 800). When executed by the one or more processors, the computer-executable instructions of the ridge extraction system 102 cause the computing device 800 to perform the methods described herein. Alternatively, the components of the ridge extraction system 102 comprises hardware, such as a special purpose processing device to perform a certain function or group of functions. Additionally, or alternatively, the components of the ridge extraction system 102 includes a combination of computer-executable instructions and hardware.

Furthermore, the components of the ridge extraction system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the ridge extraction system 102 may be implemented as part of a stand-alone application on a personal computing device or a mobile device. Alternatively, or additionally, the components of the ridge extraction system 102 may be implemented in any application that allows creation and delivery of marketing content to users, including, but not limited to, applications in ADOBE® EXPERIENCE MANAGER and CREATIVE CLOUD®, such as ADOBE® PHOTOSHOP®, ILLUSTRATOR®, and INDESIGN®. “ADOBE,” “ADOBE EXPERIENCE MANAGER,” “CREATIVE CLOUD,” “PHOTOSHOP,” “ILLUSTRATOR,” and “INDESIGN” are either registered trademarks or trademarks of Adobe Inc. in the United States and/or other countries.

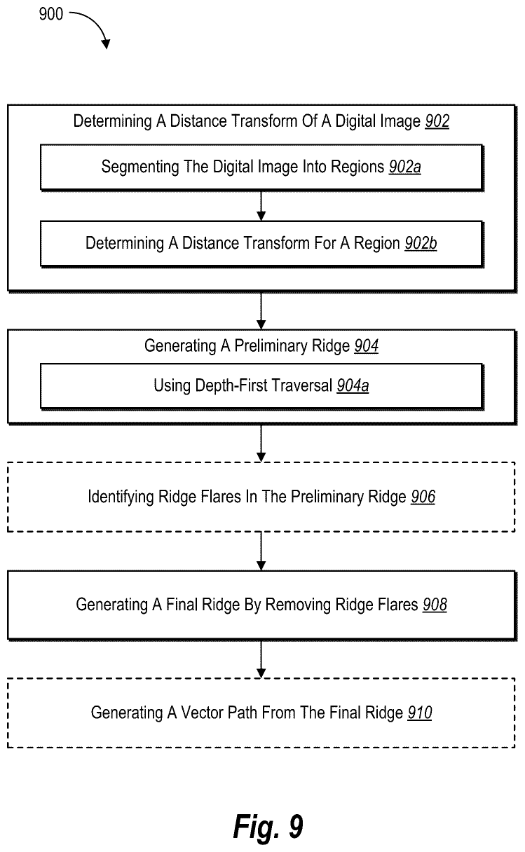

FIGS. 1-8, the corresponding text, and the examples provide a number of different systems, methods, and non-transitory computer readable media for generating ridges from digital images and vectorizing the ridges into vector paths. In addition to the foregoing, embodiments are describable in terms of flowcharts comprising acts for accomplishing a particular result. For example, FIG. 9 illustrates a flowchart of an example sequences or series of acts in accordance with one or more embodiments.

While FIG. 9 illustrates acts according to particular embodiments, alternative embodiments may omit, add to, reorder, and/or modify any of the acts shown in FIG. 9. The acts of FIG. 9 are sometimes performed as part of a method. Alternatively, a non-transitory computer readable medium comprises instructions, that when executed by one or more processors, cause a computing device to perform the acts of FIG. 9. In still further embodiments, a system performs the acts of FIG. 9. Additionally, the acts described herein may be repeated or performed in parallel with one another or in parallel with different instances of the same or other similar acts.

FIG. 9 illustrates an example series of acts 900 for extracting a ridge from a digital image and generating a vector path from the ridge. In particular, the series of acts 900 includes an act 902 of determining a distance transform of a digital image. For example, the act 902 involves determining, for a digital image, a distance transform defining distances of foreground pixels from background pixels depicted in the digital image. In some cases, the act 902 includes an act 902a of segmenting the digital image into regions. For example, the act 902a involves segmenting a digital image into a plurality of regions. In addition, the act 902 includes an act 902b of determining a distance transform for a region. For example, the act 902b involves determining, for a region of the plurality of regions, a distance transform defining distances of foreground pixels from background pixels depicted in the region.

As shown, the series of acts 900 includes an act 904 of generating a preliminary ridge. In particular, the act 904 includes an act 904a of using depth-first traversal. For example, the act 904 and/or the act 904a involve generating a preliminary ridge for the digital image by using a depth-first traversal starting at an initial pixel indicated by the distance transform and growing based on local distance transform comparisons among the foreground pixels of the digital image.

Additionally, in some embodiments, the series of acts 900 includes an act 906 of identifying ridge flares in the preliminary ridge. For example, the act 906 involves identifying one or more ridge flares in the preliminary ridge by comparing nearest background pixels for pixels along the preliminary ridge. As further illustrated in FIG. 9, the series of acts 900 includes an act 908 of generating a final ridge by removing ridge flares. For example, the act 908 involves generating a final ridge from the preliminary ridge by removing spurious pixels included in the one or more ridge flares. In some cases, the act 908 involves generating a final ridge from the preliminary ridge by removing spurious pixels included in ridge flares.

In some embodiments, the series of acts 900 includes an act 910 of generating a vector path from the final ridge. For example, the act 910 involves generating, using a curve fitting function, a vector path from the final ridge to convert the digital image from a raster version to a vector version. In some cases, the act 910 involves generating a vector path from the final ridge using a curve fitting function.

In one or more embodiments, the series of acts 900 includes an act of generating the preliminary ridge using the depth-first traversal by: determining, as the initial pixel, a global maximum pixel comprising a pixel with a farthest distance from a nearest background pixel, and growing the preliminary ridge from the global maximum pixel. In these or other embodiments, the series of acts 900 includes an act of determining the distance transform by: determining a distance from a foreground pixel in the digital image to a nearest background pixel of the foreground pixel, and assigning the distance as a distance transform value for the foreground pixel.

In some embodiments, the series of acts 900 includes an act of identifying the spurious pixels by determining one or more ridge flares along the preliminary ridge, wherein determining the one or more ridge flares comprises comparing nearest background pixels for pixels along the preliminary ridge. In certain embodiments, the series of acts 900 includes an act of generating a vector path from the final ridge using a curve fitting function. In one or more embodiments, the series of acts 900 includes an act of determining the distance transform for the digital image by: segmenting the digital image into regions, converting the regions into black and white representations, wherein black pixels represent background content and white pixels represent foreground content, and assigning distance transform values to the white pixels according to respective distances to nearest black pixels.

In certain embodiments, the series of acts 900 includes an act of identifying the ridge flares in the preliminary ridge by: detecting one or more of an endpoint or a junction along the preliminary ridge, and determining an orthogonal protrusion occurring at the one or more of the endpoint or the junction by determining that points along the orthogonal protrusion share a common nearest background pixel. In some embodiments, the series of acts 900 includes an act of converting the plurality of regions into black and white representations depicting black pixels representing background content and white pixels representing foreground content. In some cases, the series of acts 900 includes an act of differentiating between foreground pixels depicting foreground content in the regions and background pixels depicting background content in the regions. Additionally, the series of acts 900 includes an act of assigning distance transform values to the foreground pixels according to respective distances to nearest background pixels.

In addition, the series of acts 900 includes an act of determining the distance transform for the region by assigning distance transform values to one or more white pixels in the region according to distances of the one or more white pixels to nearest black pixels. Further, the series of acts 900 includes an act of generating the preliminary ridge by: determining an initial pixel in the region for starting the depth-first traversal as indicated by the distance transform, and performing the depth-first traversal to add pixels to the preliminary ridge along with the initial pixel based on the local distance transform comparisons.

In one or more embodiments, the series of acts 900 includes an act of performing the local distance transform comparisons by identifying local maximum pixels with distance transform values satisfying a four-way local maxima test. In addition, the series of acts 900 includes an act of including the local maximum pixels within the preliminary ridge. Further, the series of acts 900 includes an act of generating the vector path by generating a vectorized version of a text character from the digital image depicting a raster version of the text character.

In certain embodiments, the series of acts 900 includes an act of performing the local distance transform comparisons by: adding pixels to a stack ordered according to deviation from a discovery direction along the preliminary ridge, and performing a local maxima test on the pixels according to their order in the stack. In addition, the series of acts 900 includes an act of performing the local maxima test by comparing a distance transform value of a target pixel with distance transform values of adjacent pixels in one or more directions.

In some embodiments, the series of acts 900 includes an act of performing the local maxima test by: comparing a first distance transform value of a target pixel along the preliminary ridge with a second distance transform value of an adjacent pixel, determining that the second distance transform value is within a threshold difference of the first distance transform value, and in response to determining that the second distance transform value is within the threshold difference of the first distance transform value, comparing the first distance transform value with a third distance transform value of a pixel one degree removed along a normal from the target pixel.

In certain embodiments, the series of acts 900 includes an act of identifying the one or more ridge flares by: detecting one or more of an endpoint or a junction along the preliminary ridge, and determining a ridge flare occurring at the one or more of the endpoint or the junction by determining that points along the ridge flare share a common nearest background pixel. Further, the series of acts 900 includes an act of generating the final ridge by generating a contiguous path of pixels that is one pixel wide at all points.

Embodiments of the present disclosure may comprise or use a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) use transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 10 illustrates a block diagram of an example computing device 1000 that may be configured to perform one or more of the processes described above. One will appreciate that one or more computing devices, such as the computing device 1000 may represent the computing devices described above (e.g., computing device 800, server device(s) 104, and/or client device 108). In one or more embodiments, the computing device 1000 may be a mobile device (e.g., a mobile telephone, a smartphone, a PDA, a tablet, a laptop, a camera, a tracker, a watch, a wearable device, etc.). In some embodiments, the computing device 1000 may be a non-mobile device (e.g., a desktop computer or another type of client device). Further, the computing device 1000 may be a server device that includes cloud-based processing and storage capabilities.

As shown in FIG. 10, the computing device 1000 can include one or more processor(s) 1002, memory 1004, a storage device 1006, input/output interfaces 1008 (or “I/O interfaces 1008”), and a communication interface 1010, which may be communicatively coupled by way of a communication infrastructure (e.g., bus 1012). While the computing device 1000 is shown in FIG. 10, the components illustrated in FIG. 10 are not intended to be limiting. Additional or alternative components may be used in other embodiments. Furthermore, in certain embodiments, the computing device 1000 includes fewer components than those shown in FIG. 10. Components of the computing device 1000 shown in FIG. 10 will now be described in additional detail.

In particular embodiments, the processor(s) 1002 includes hardware for executing instructions, such as those making up a computer program. As an example, and not by way of limitation, to execute instructions, the processor(s) 1002 may retrieve (or fetch) the instructions from an internal register, an internal cache, memory 1004, or a storage device 1006 and decode and execute them.

The computing device 1000 includes memory 1004, which is coupled to the processor(s) 1002. The memory 1004 may be used for storing data, metadata, and programs for execution by the processor(s). The memory 1004 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1004 may be internal or distributed memory.

The computing device 1000 includes a storage device 1006 includes storage for storing data or instructions. As an example, and not by way of limitation, the storage device 1006 can include a non-transitory storage medium described above. The storage device 1006 may include a hard disk drive (HDD), flash memory, a Universal Serial Bus (USB) drive or a combination these or other storage devices.

As shown, the computing device 1000 includes one or more I/O interfaces 1008, which are provided to allow a user to provide input to (such as user strokes), receive output from, and otherwise transfer data to and from the computing device 1000. These I/O interfaces 1008 may include a mouse, keypad or a keyboard, a touch screen, camera, optical scanner, network interface, modem, other known I/O devices or a combination of such I/O interfaces 1008. The touch screen may be activated with a stylus or a finger.

The I/O interfaces 1008 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1008 are configured to provide graphical data to a display for presentation to a user. The graphical data may be representative of one or more graphical user interfaces and/or any other graphical content as may serve a particular implementation.

The computing device 1000 can further include a communication interface 1010. The communication interface 1010 can include hardware, software, or both. The communication interface 1010 provides one or more interfaces for communication (such as, for example, packet-based communication) between the computing device and one or more other computing devices or one or more networks. As an example, and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI. The computing device 1000 can further include a bus 1012. The bus 1012 can include hardware, software, or both that connects components of computing device 1000 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method comprising:
determining, for a digital image, a distance transform defining distances of foreground pixels from background pixels depicted in the digital image;
generating a preliminary ridge for the digital image by using a depth-first traversal starting at an initial pixel indicated by the distance transform and growing based on local distance transform comparisons among the foreground pixels of the digital image; and
generating a final ridge from the preliminary ridge by removing spurious pixels included in ridge flares.

2. The method of claim 1, further comprising generating, using a curve fitting function, a vector path from the final ridge to convert the digital image from a raster version to a vector version.

3. The method of claim 1, wherein generating the preliminary ridge using the depth-first traversal comprises:
determining, as the initial pixel, a global maximum pixel comprising a pixel with a farthest distance from a nearest background pixel; and
growing the preliminary ridge from the global maximum pixel.

4. The method of claim 1, wherein determining the distance transform comprises:
determining a distance from a foreground pixel in the digital image to a nearest background pixel of the foreground pixel; and
assigning the distance as a distance transform value for the foreground pixel.

5. The method of claim 1, further comprising identifying the spurious pixels by determining one or more ridge flares along the preliminary ridge, wherein determining the one or more ridge flares comprises comparing nearest background pixels for pixels along the preliminary ridge.

6. The method of claim 1, further comprising generating a vector path from the final ridge using a curve fitting function.

7. The method of claim 1, wherein determining the distance transform for the digital image comprises:
segmenting the digital image into regions;
differentiating between background pixels depicting background content in the regions and foreground pixels depicting foreground content in the regions; and
assigning distance transform values to the foreground pixels according to respective distances to nearest background pixels.

8. A system comprising:
a memory component; and
one or more processing devices coupled to the memory component, the one or more processing devices to perform operations comprising:
segmenting a digital image into a plurality of regions;
determining, for a region of the plurality of regions, a distance transform defining distances of foreground pixels from background pixels depicted in the region;
generating a preliminary ridge for the digital image by using a depth-first traversal to traverse the foreground pixels in the region based on local distance transform comparisons;
generating a final ridge from the preliminary ridge by removing spurious pixels included in ridge flares; and
generating a vector path from the final ridge using a curve fitting function.

9. The system of claim 8, wherein the operations further comprise identifying the ridge flares in the preliminary ridge by:
detecting one or more of an endpoint or a junction along the preliminary ridge; and
determining an orthogonal protrusion occurring at the one or more of the endpoint or the junction by determining that points along the orthogonal protrusion share a common nearest background pixel.

10. The system of claim 8, wherein the operations further comprise converting the plurality of regions into black and white representations depicting black pixels representing background content and white pixels representing foreground content.

11. The system of claim 10, wherein determining the distance transform for the region comprises assigning distance transform values to one or more white pixels in the region according to distances of the one or more white pixels to nearest black pixels.

12. The system of claim 8, wherein generating the preliminary ridge comprises:
determining an initial pixel in the region for starting the depth-first traversal as indicated by the distance transform; and
performing the depth-first traversal to add pixels to the preliminary ridge along with the initial pixel based on the local distance transform comparisons.

13. The system of claim 8, wherein the operations further comprise:
performing the local distance transform comparisons by identifying local maximum pixels with distance transform values satisfying a four-way local maxima test; and
including the local maximum pixels within the preliminary ridge.

14. The system of claim 8, wherein generating the vector path comprises generating a vectorized version of a text character from the digital image depicting a raster version of the text character.

15. A non-transitory computer readable medium storing instructions which, when executed by a processing device, cause the processing device to perform operations comprising:
determining, for a digital image, a distance transform defining distances of foreground pixels from background pixels depicted in the digital image;
generating a preliminary ridge for the digital image by using a depth-first traversal to traverse the foreground pixels of the digital image following local distance transform comparisons;
identifying one or more ridge flares in the preliminary ridge by comparing nearest background pixels for pixels along the preliminary ridge; and
generating a final ridge from the preliminary ridge by removing spurious pixels included in the one or more ridge flares.

16. The non-transitory computer readable medium of claim 15, wherein the operations further comprise performing the local distance transform comparisons by:
adding pixels to a stack ordered according to deviation from a discovery direction along the preliminary ridge; and
performing a local maxima test on the pixels according to their order in the stack.

17. The non-transitory computer readable medium of claim 16, wherein performing the local maxima test comprises comparing a distance transform value of a target pixel with distance transform values of adjacent pixels in one or more directions.

18. The non-transitory computer readable medium of claim 16, wherein performing the local maxima test comprises:
comparing a first distance transform value of a target pixel along the preliminary ridge with a second distance transform value of an adjacent pixel;
determining that the second distance transform value is within a threshold difference of the first distance transform value; and
in response to determining that the second distance transform value is within the threshold difference of the first distance transform value, comparing the first distance transform value with a third distance transform value of a pixel one degree removed along a normal from the target pixel.

19. The non-transitory computer readable medium of claim 15, identifying the one or more ridge flares comprises:
detecting one or more of an endpoint or a junction along the preliminary ridge; and
determining a ridge flare occurring at the one or more of the endpoint or the junction by determining that points along the ridge flare share a common nearest background pixel.

20. The non-transitory computer readable medium of claim 15, generating the final ridge comprises generating a contiguous path of pixels that is one pixel wide at all points.
